(19) United States
(12) Patent Application Publication
(10) Pub. No.: US 2026/0330387 A1
(43) Pub. Date: Oct. 22, 2026

(54) ACTION PLAN RESOLUTION FOR PRIORITY OF SCORING WITH REINFORCEMENT LEARNING AND MATHEMATICAL MODELING

(71) Applicant: Palo Alto Networks, Inc., Santa Clara, CA (US)

(72) Inventors: Venkatesh Kumaran Pappakrishnan, Dublin, CA (US); Ruben Dario Torres Guerra, Menlo Park, CA (US); Alok Tongaonkar, San Jose, CA (US)

(21) Appl. No.: 19/185,067

(22) Filed: Apr. 21, 2025

(51) Int. Cl. G06Q 10/0639; G06Q 10/0637

(52) U.S. Cl. CPC G06Q 10/06393; G06Q 10/0637

(57) ABSTRACT

An action plan scoring reinforcement learner (“reinforcement learner”) iteratively updates weights for scoring action plans using feedback and by choosing weights to reduce a loss function. At each iteration, the reinforcement learner scores a set of action plans using a current set of weights. The reinforcement learner generates a ranking based on the scores and communicates the generated ranking to an organization. The reinforcement learner receives feedback on the generated ranking and determines an expected ranking from the feedback. The reinforcement learner then updates the weights to reduces/minimize the weights based on a loss function between the expected ranking and the generated ranking. Reinforcement learning iterations continue until an expected ranking and generated ranking at an iteration are close or identical.

### BACKGROUND

The disclosure generally relates to data processing and computing arrangements based on computational models (e.g., CPC subclass G06N and CPC subclass G06F 16).

The National Institute of Standards and Technology (NIST) Special Publication 800-34 Rev. 1 defines an “Incident Response Plan” as, “The documentation of a predetermined set of instructions or procedures to detect, respond to, and limit consequences of a malicious cyber attacks [Sic] against an organization's information system(s).” Incident Response Plans are constrained to predefined documentation across an organization, and as such responses to malicious cyber attacks are limited to those codified in the documentation.

Reinforcement learning is a machine learning framework in which an agent learns to perform actions at least based on an environment, a policy for the agent, and a state of the agent and/or environment. At each iteration of reinforcement learning, the agent observes the state and determines an action to perform based on the policy and state. The agent then receives feedback on the action from the environment and updates its state/policy to optimize future actions (i.e., maximize rewards obtained from feedback from the environment at future iterations).

### BRIEF DESCRIPTION OF THE DRAWINGS

Embodiments of the disclosure may be better understood by referencing the accompanying drawings.

FIG. 1 is a diagram of an example system for action plan scoring with reinforcement learning and mathematical modeling.

FIG. 2 is an illustrative diagram that conceptualizes various components of action plan scoring in a reinforcement learning framework.

FIG. 3 is a flowchart of example operations for updating and deploying a mathematical model for action plan scoring with reinforcement learning.

FIG. 4 is a flowchart of example operations for updating weights based on a loss function and generating updated action plan scores with the updated weights.

FIG. 5 depicts an example computer system with an action plan scoring reinforcement learner and an action plan scorer.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

For overall efficiency of alert resolution, an organization may associate alerts based on common characteristics of the alerts (e.g., common resources, security policies, etc.) and generate sequences of steps that simultaneously resolve alerts within each associated set (hereafter “action plans”). However, even with this added efficiency, the organization may still struggle to promptly resolve action plans. This issue is ameliorated by prioritizing action plans for importance of resolution using a scoring methodology. Key factors for action plan scoring include risk, resolution impact, and resolution complexity (or, alternatively, fix simplicity). The relative importance of each of these factors can vary heavily depending on the characteristics and priorities of the organization. As a result, the use of reinforcement learning in the context of action plan scoring has the potential to significantly increase scoring quality on an organization-by-organization basis.

The present disclosure proposes an action plan scoring reinforcement learner (“reinforcement learner”) that iteratively receives feedback from an organization to improve action plan scoring with reinforcement learning. As a baseline, the reinforcement learner uses scoring variables for each of the factors (risk, resolution impact, and resolution complexity) and corresponding weights to score action plans for priority of resolution. For a batch of action plans, the reinforcement learner scores the batch of action plans with default weights and generates a ranking of the batch of action plans using the scores. At each iteration, the reinforcement learner receives feedback on the generated ranking from the organization and determines an expected ranking based on the feedback. The reinforcement learner then updates the weights according to a loss function between the expected ranking and the generated ranking. When, at an iteration, the feedback either indicates that the generated ranking is correct or sufficiently accurate (e.g., based on a value of a loss function between the expected ranking and generated ranking being below a threshold value), the reinforcement learner saves the weights updated from the most recent iteration for subsequent scoring and ranking of action plans. Action plan scoring with optimization of weights using these reinforcement learning iterations results in scores that accurately reflect priorities of action plan scores (especially for the aforementioned scoring factors), resulting in higher prioritization of meaningful action plans to the organization.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

The term “action plan” as used herein refers to a documented set of steps that is designed to resolve a set of associated alerts. Action plan is used herein to refer to either the documented set of steps or both the documented set of steps and the associated set of alerts that the set of steps attempts to resolve. An action plan need not be predetermined by an organization and can be generated as sets of alerts are associated for resolution.

### Example Illustrations

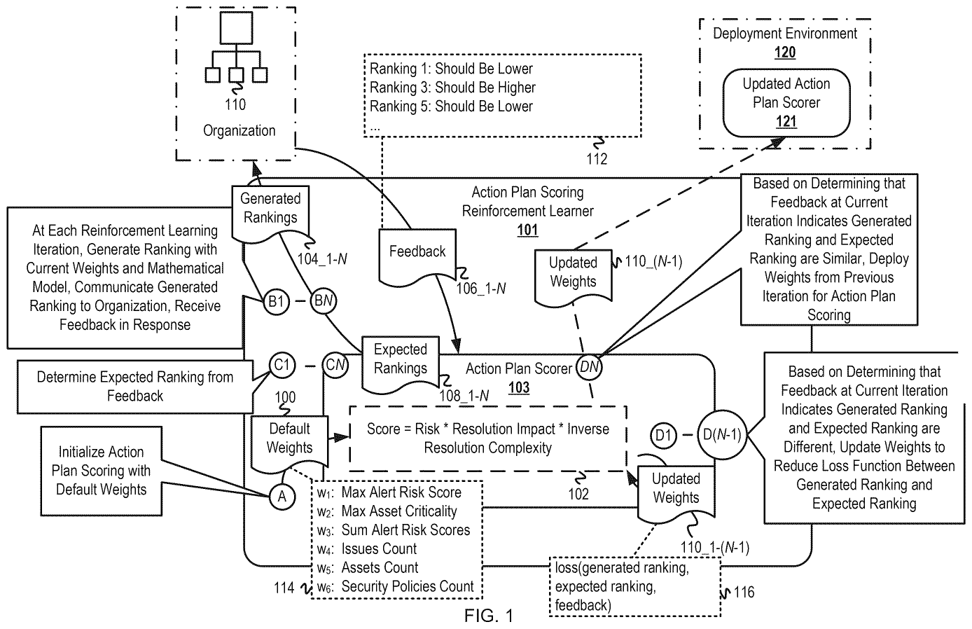

FIG. 1 is a diagram of an example system for action plan scoring with reinforcement learning and mathematical modeling. FIG. 1 depicts an action plan scoring reinforcement learner (“reinforcement learner”) 101 comprising an action plan scorer 103 that interacts with an organization 110 in one or more reinforcement learning iterations to update weights of scoring variables for action plan scoring as the weights are adapted/adjusted to an environment of the organization 110. FIG. 1 is annotated with a series of letters/numbers A, B1-BN, C1-CN, and D1-DN representing stages of operations, each stage corresponding to one or more operations. The stages B1-BN, C1-CN, and D1-DN represent N iterations (N>=1) of reinforcement learning until, at the Nth iteration, an expected ranking determined from feedback from the organization 110 is sufficiently similar to a generated ranking for that iteration. Although these stages are ordered for this example, the stages illustrate one example to aid in understanding this disclosure and should not be used to limit the claims. Subject matter falling within the scope of the claims can vary from what is illustrated.

A stage A, the reinforcement learner 101 initializes the action plan scorer 103 with default weights 100. Each of the default weights 100 is a weight for a scoring variable that will be used in a mathematical model 102 for action plan scoring. The default weights 100 are weights known to be accurate for action plan scoring across a wide variety of organizations. For instance, the reinforcement learner 101 can set the default weights 100 as an average of previously computed weights for other organizations. When there is not enough data from other organizations, the default weights 100 can comprise weights set by a domain-level expert based on expected weighting of various scoring variables. Example weights 114 include, for each action plan, maximum alert risk score weight w₁, maximum asset criticality weight w₂, sum of alert risk scores weight w₃, issues count weight w₄, assets count weight w₅, and security policies count weight w₆.

The mathematical model 102 comprises the following formula for action plan scoring:

Score=Risk*Resolution Impact*Inverse Resolution Complexity

The above formula represents how the three key factors for action plan scoring are combined (i.e., multiplied) when explicitly computing action plan scores. Inverse resolution complexity can alternatively be referred to as fix simplicity. Each of the factors in the above formula are scored for each action plan using values of the aforementioned scoring variables according to the following formulae:

$$Risk = exp ( w 1 * max\_risk \_score / max ( max\_risk \_score ) - 1 ) * exp ( w 2 * max\_asset \_crit / max ( \_asset \_crit ) - 1 ) * exp ( w 3 sum\_risk \_score / sum ( sum\_risk \_score ) - 1 )$$

$$Resolution Impact = log ( 1 + w 4 [ num\_issues / max ( num\_issues ) ] ) + log ( 1 + w 5 [ num\_assets / max ( num\_assets ) ] )$$

$$Inverse Resolution Complexity = exp ( - w 6 * p / max ( p ) )$$

In the above formulae, w₁-w₆ are weights initialized as the default weights 100 that can vary across subsequent reinforcement learning iterations. max_risk_score is a maximum alert risk score scoring variable, max_asset_crit is a maximum asset criticality scoring variable, sum_risk_scores is a sum of alert risk scores scoring variable, num_issues is an issues count scoring variable, num_assets is an assets count scoring variable, and p is a security policies count scoring variable. Each of the foregoing scoring variables takes values for a corresponding action plan when scoring that action plan using the above formulae. By contrast, the notation “max(x)” in the above formulae for a scoring variable x refers to the maximum value of that scoring variable across all previously observed action plans for the organization 110. The num_issues scoring variable can alternatively be the number of alerts or the number of alerts plus the number of issues for an action plan.

The present disclosure covers any mathematical model that includes weights for scoring variables for scoring action plans and is not limited to the foregoing formulae and examples of scoring variables. For instance, the mathematical model 102 can use additional, less, or alternative scoring variables and/or factors. The mathematical model 102 can vary by the type of formulae, representations of concepts, etc. As an example, Resolution Impact can be scaled linearly instead of logarithmically in the above formulae.

At each of the stages B1-BN, the action plan scorer 103 generates a corresponding ranking in generated rankings 104_1-N using weights at a current reinforcement learning iteration and the mathematical model 102. The action plan scorer then communicates the ranking in the generated rankings 104_1-N for the current iteration to the organization 110, and the action plan scorer 103 receives corresponding feedback in feedback 106_1-N in response. Each of the generated rankings 104_1-N is a ranking according to ascending action plan scores of action plans in a set of multiple action plans (not depicted), with action plans having higher scores having higher rankings (i.e., higher priority of resolution) when using the above formulae. The set of action plans for which the action plan scorer 103 generates each of the generated rankings 104_1-N is the same across reinforcement learning iterations and is typically all action plans observed by the organization 110, although less action plans can be chosen to reduce the workload in providing feedback at each iteration.

Each of the feedback 106_1-N comprises feedback from one or more users and/or administrators at the organization 110 regarding a corresponding generated ranking in the generated rankings 104_1-N. For a generated ranking, the feedback from each user can indicate, for each action plan in the generated ranking, a thumbs up or thumbs down that indicates whether the ranking of the action plan is correct, an indication of whether the action plan should be ranked higher, lower, or the same, an exact expected rank for the action plan, etc. Example feedback 112 from a single user of the organization comprises an indication that the ranking of the first ranked action plan should be lower, that the ranking of the third ranked action plan should be higher, and that the ranking of the fifth ranked action plan should be lower.

At each of the stages C1-CN, the reinforcement learner 101 determines an expected ranking from expected rankings 108_1-N based on corresponding feedback from the feedback 106_1-N. The feedback 106_1-N can explicitly indicate the expected ranking that can be provided by a representative user or administrator of the organization 110. In some embodiments, the reinforcement learner 101 can determine the expected ranking based on indications in the feedback 106_1-N that rankings should be higher, lower, or the same.

At each of stages D1-D(N−1), the reinforcement learner 101 determines that feedback from the feedback 106_1-N for the current iteration indicates that the corresponding generated ranking and the expected ranking from the generated rankings 104_1-N and expected rankings 108_1-N, respectively, are different. The reinforcement learner 101 makes this determination based on a value of a loss function 116:

loss(generated ranking, expected ranking, feedback)=Σₐₚ weightₐₚ*[|(expected ranking)ₐₚ−(generated ranking)ₐₚ|]

The above sum in the loss function 116 is over all action plans (“ap”) with weights weightₐₚ determined from the feedback. As an example of calculating action plan weights in the loss function 116, when the feedback is an indication that the action plan should be ranked higher, lower, or the same for the action plan, then the weight of the action plan can be the number of users that indicated a higher ranking plus the number of users that indicated a lower ranking. Thus, action plans having more user votes indicating an incorrect ranking in the feedback get higher weights in the loss function 116. The weights weightₐₚ can be normalized by the maximum weights across all action plans for the organization 110 so that the weights are in the interval [0,1]. The reinforcement learner 101 determines that the feedback indicates that the generated ranking and the expected ranking are different by determining that the value of the loss function is greater than or equal to a threshold value. This threshold value can be a preconfigured value based on domain-level knowledge.

Based on determining that the above value of the loss function 116 is greater than or equal to the threshold value, the reinforcement learner 101 determines a set of updated weights in updated weights 110_1-(N−1) that lowers the value of the loss function 116. The reinforcement learner 101 varies the set of weights in the mathematical model 102 using an algorithm that attempts to minimize or reduce the loss function 116 (e.g., an optimization algorithm such as grid search). For each variation of the weights according to the algorithm, the action plan scorer 103 determines an updated generated ranking for the variation of the set of weights by rescoring the set of action plans with the mathematical model 102. The reinforcement learner 101 then uses the updated generated ranking in the loss function 116 (with the expected ranking and action plan weights for the current reinforcement learning iteration) to generate an updated value of the loss function 116. The set of weights having the lowest updated value of the loss function 116 among all the variations of weights are chosen by the reinforcement learner 101 as the set of updated weights in the updated weights 110_1-(N−1).

At stage DN, the reinforcement learner 101 determines that the value of the loss function 116 evaluated using the generated ranking 104_N, the expected ranking 108_N, and the feedback 106_N is below the threshold value. The reinforcement learner 101 then deploys the updated weights 110_(N−1) from the previous iteration (that were used in generating the generated ranking 104_N) in the mathematical model 102 to obtain an updated action plan scorer 121 that is deployed in a deployment environment 120. If N=1, then the default weights 100 are deployed in the mathematical model 102. In the deployment environment 120, the updated action plan scorer 121 ranks additional action plans for the organization 110 (that can include those used during reinforcement learning), and the organization 110 or cybersecurity component associated with the organization resolves the additional action plans in order according to the ranking.

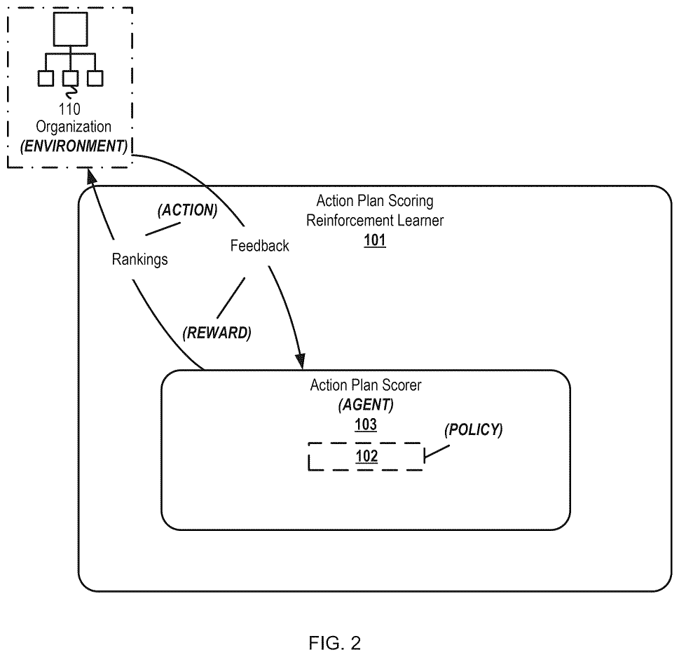

FIG. 2 is an illustrative diagram that conceptualizes various components of action plan scoring in a reinforcement learning framework. FIG. 2 depicts the reinforcement learner 101, the action plan scorer 103, the mathematical model 102, and the organization 110 from FIG. 1. FIG. 2 characterizes the action plan scorer 103 as an agent, the mathematical model 102 as a policy, rankings as actions, the organization 110 as an environment, and feedback as rewards in a reinforcement learning framework. These characterizations are subjective to the interpretation of the framework. For instance, the environment can instead be characterized as action plans for the organization 110 and characteristics thereof. The reinforcement learner 101 can be characterized as the agent. The feedback or aspects of the feedback can be characterized as both the state and reward.

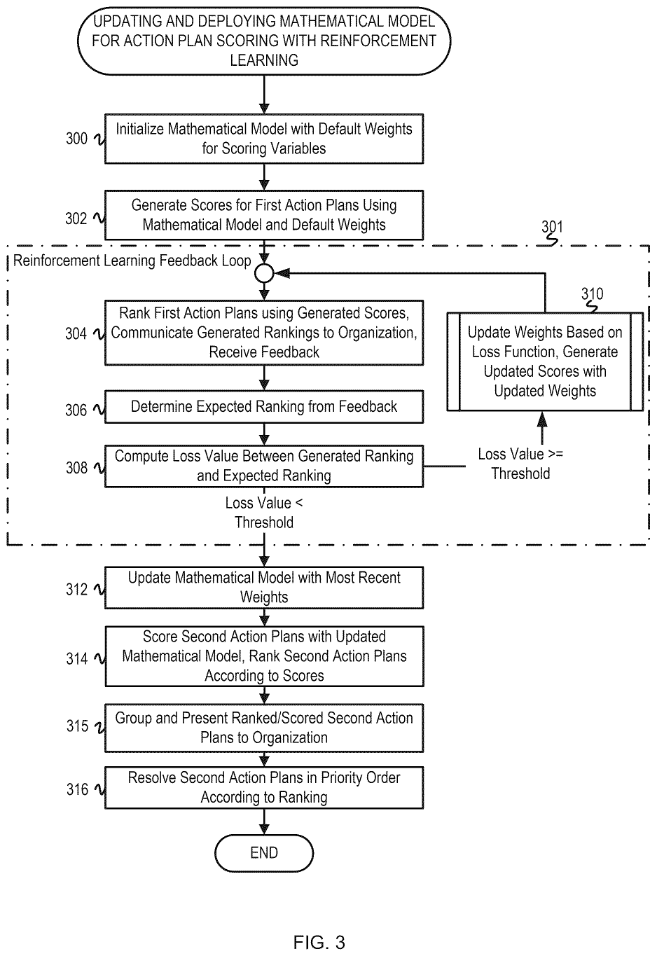

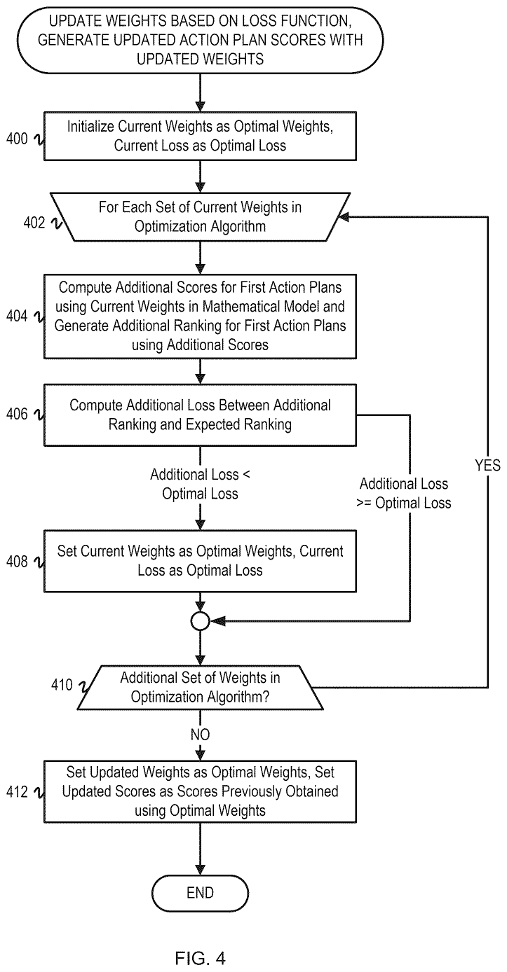

FIGS. 3-4 are flowcharts of example operations for scoring action plans with reinforcement learning and mathematical modeling. The example operations are described with reference to an action plan reinforcement learner (“reinforcement learner”), an action plan scorer, and a mathematical model for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for updating and deploying a mathematical model for action plan scoring with reinforcement learning. At block 300, the reinforcement learner initializes the mathematical model with default weights for scoring variables. The scoring variables can comprise any of the aforementioned scoring variables related to risk, resolution impact, resolution complexity, etc. The default weights can be weights for the scoring variables that are known to be effective across multiple contexts, for instance by averaging scoring variable weights for mathematical models used by multiple organizations. The mathematical model can comprise any formula(e) used for action plan scoring involving weights, e.g., any formulae in the foregoing.

At block 302, the action plan scorer generates scores for first action plans using the mathematical model and default weights. The first action plans comprise action plans generated for an organization that will be used throughout a reinforcement learning feedback loop 301. Operations for the reinforcement learning feedback loop 301 are described in reference to blocks 304, 306, 308, and 310, and continue until the reinforcement learner determines that a loss value at an iteration is below a threshold value. In some embodiments, the reinforcement learning feedback loop 301 may instead terminate when a threshold number of iterations or other external criterion occurs.

At block 304, the reinforcement learner ranks the first action plans using the generated scores and communicates the generated ranking to the organization. The reinforcement learner then receives feedback from the organization in response. The feedback indicates, for each action plan in the generated ranking, whether the action plan should be ranked higher, lower, or the same, an exact expected ranking for the action plan, etc.

At block 306, the reinforcement learner determines an expected ranking from the feedback. The feedback can explicitly indicate the expected ranking, or the reinforcement learner can infer the expected ranking from indications in the feedback that rankings should be higher, lower, or the same.

At block 308, the reinforcement learner computes a loss value between the generated ranking and the expected ranking based on the feedback. The reinforcement learner computes the loss value as a weighted sum of differences between the expected ranking and the generated ranking for each action plan, with weights for each action plan in the sum computed based on the feedback. As an example, for an action plan having 10 user votes to be higher ranked, 20 user votes to be lower ranked, and 15 user votes to be the same rank indicated in the feedback, and having an expected rank of 5 and generated rank of 3, the term for the action plan in the sum would be (10+20)*(|5−3|)=60. The action plan weights can be normalized by a maximum action plan weight observed by the organization so that they are in the interval [0,1]. If the loss value is greater than or equal to a preconfigured threshold value (e.g., as determined by a domain-level expert and tuned during reinforcement learning across organizations), i.e., the generated ranking is incorrect, operational flow proceeds to block 310. Otherwise, if the generated ranking is correct, operational flow proceeds to block 312.

At block 310, the reinforcement learner updates weights for the mathematical model based on the loss function and generates updated scores with the updated weights. The operations at block 310 are described in greater detail in reference to FIG. 4. Operational flow returns to block 304.

At block 312, the reinforcement learner updates the mathematical model with the most recent weights from a most recent iteration of the reinforcement learning feedback loop 301. The mathematical model may already have been updated/configured to have these most recent weights at the most recent iteration, in which case the operations at this block may be omitted.

At block 314, the reinforcement learner scores second action plans for the organization with the updated mathematical models and ranks the second action plans according to the scores. The second action plans are additional action plans generated by the organization or a cybersecurity component of the organization in a deployment environment and can include the first action plans used for reinforcement learning.

At block 315, the reinforcement learner groups and presents the ranked/scored second action plans to the organization. The groupings can be according to ranges of scores for the second action plans, wherein each grouping indicates a severity for resolution such as “critical”, “high”, “medium”, “low”, etc. The operations for grouping ranked action plans can additionally at block 304 when communicating the generated rankings to the organization at each iteration of the reinforcement learning feedback loop 301.

At block 316, the organization or cybersecurity component of the organization resolves the second action plans in priority order according to the ranking. The organization can subsequently continue to evaluate the rankings, and the weights of the mathematical model and the mathematical model itself can be updated/tuned in the future as rankings degrade.

FIG. 4 is a flowchart of example operations for updating weights based on a loss function and generating updated action plan scores with the updated weights. The operations in FIG. 4 assume current weights for action plan scoring and that, for the first action plans above, there is feedback on a generated ranking of the first action plans and an expected ranking of the first action plans determined based on the feedback.

At block 400, the reinforcement learner initializes the current weights as optimal weights and the current loss as an optimal loss. The optimal weights and optimal loss are subsequently updated in an optimization algorithm to determine weights that minimize or reduce loss when the first action plans have the expected ranking and feedback. The optimization algorithm is a subroutine of a reinforcement learning framework that occurs once an expected ranking and feedback are determined at an iteration of the reinforcement learning framework. This paragraph and the remainder of FIG. 4 refers to “loss” as an equivalent to “loss value” or “value of loss function” described in the foregoing.

At block 402, the reinforcement learner beings iterating through sets of current weights in an optimization algorithm. Example optimization algorithms that can be implemented by the reinforcement learner include gradient descent and numerical optimization techniques.

At block 404, the reinforcement learner computes additional scores for the first action plans using the current weights in the mathematical model. The reinforcement learner then generates an additional ranking for the first action plans using the additional scores.

At block 406, the reinforcement learner computes an additional loss between the additional ranking and the expected ranking using the feedback. The reinforcement learner computes the additional loss as a weighted sum of differences between expected rankings and generated rankings with weights determined for each action plan using the feedback according to the foregoing description. If the additional loss is less than the optimal loss, operational flow proceeds to block 408. Otherwise, operational flow proceeds to block 410.

At block 408, the reinforcement learner sets the current weights as the optimal weights and the current loss as the optimal loss. This is because the current weights have a loss that is lower than all previously computed losses as part of the optimization algorithm. The reinforcement learner also stores the additional scores computed for the current weights and deletes the scores computed for the previous optimal weights from memory.

At block 410, the reinforcement learner determines if there is an additional set of weights in the optimization algorithm. If there is an additional set of weights, operational flow returns to block 402. Otherwise, operational flow proceeds to block 412.

At block 412, the reinforcement learner sets the updated weights to be the optimal weights and the updated scores to be the scores previously obtained during the optimization algorithm using the optimal weights. The updated weights and updated scores and then used in a subsequent iteration of a reinforcement learning framework.

The “optimal weights” and “optimal loss” referred to in FIG. 4 are referred to as “optimal” based on the property being determined with an optimization algorithm. An optimization algorithm merely attempts to optimize and does not always succeed in finding actual optimal values. Depending on the optimization algorithm used, the iteration of the reinforcement learning framework, and other broader factors such as quantization error, local optima, etc., the optimal weights may not be weights that minimize loss computed according to the loss function using rankings generated with the optimal weights. Moreover, the optimal weights and optimal loss are computed for a fixed expected ranking and feedback and do not attempt to minimize loss across all possible generated rankings and corresponding feedback by the organization.

### Variations

Other loss functions and mathematical models are anticipated by the present disclosure. Moreover, the loss function disclosed herein depends on the algorithm used to generate expected rankings and to weight action plans, which can vary. As a simple example, a weight for an action plan can, in some embodiments, be a greatest difference between an expected ranking and a generated ranking for the action plan indicated in feedback across all users. Action plan “resolution” can alternatively be referred to as action plan “remediation”. Although the foregoing refers to determining weights for mathematical models with reinforcement learning based on action plans for an organization, the scope of action plans can vary, for instance to encompass multiple organizations, a department of an organization, etc.

The foregoing describes determining whether to continue reinforcement learning iterations by evaluating a loss function on a generated ranking, feedback, and an expected ranking. In some embodiments, this determination can be made solely based on feedback, for instance by evaluating an average percentage of incorrect action plan rankings indicated per-user in the feedback against a threshold average percentage. This determination can moreover be made before determining expected rankings from feedback for efficiency.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 404, 460, and 408 can be performed in parallel or concurrently across optimization algorithm iterations. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

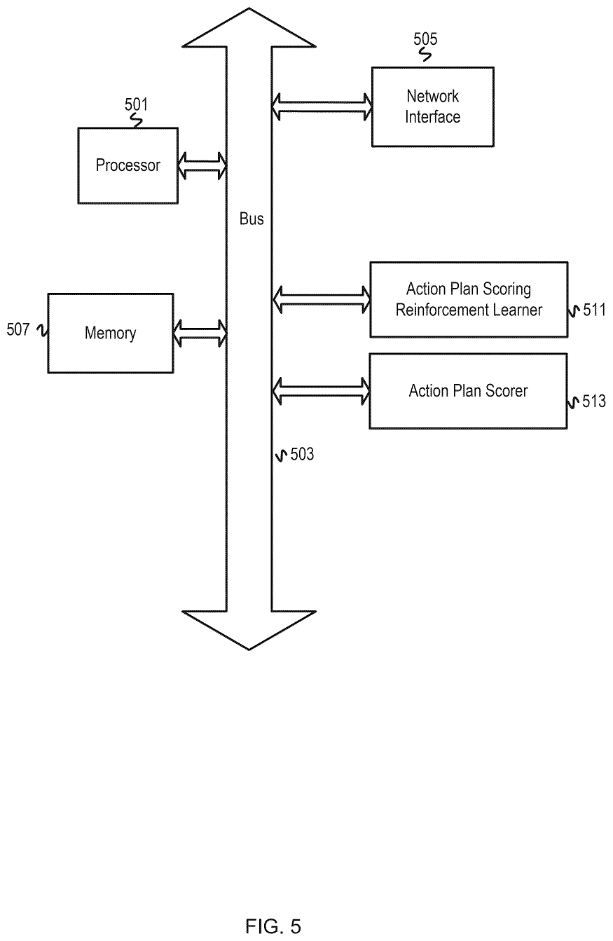

FIG. 5 depicts an example computer system with an action plan scoring reinforcement learner and an action plan scorer. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes an action plan scoring reinforcement learner (“reinforcement learner”) 511 and an action plan scorer 513. For FIG. 5, the previously described action plan scorer has been decoupled as a separate component to the previously described reinforcement learner, The reinforcement learner 511 learns weights for scoring action plans of an organization across one or more reinforcement learning iterations. At a first iteration, the reinforcement learner 511 initializes weights of a mathematical model (not depicted) implemented by the action plan scorer 513. For a set of action plans generated for the organization, the action plan scorer 513 scores the set of action plans to generate a ranking, communicates the generated ranking to the organization (i.e., users/administrators of the organization), and receives feedback from the organization in response. The reinforcement learner 511 determines action plan weights and an expected ranking based on the feedback, then applies an optimization algorithm to tune the weights of the mathematical model to minimize or reduce a loss function between the generated ranking and expected ranking that uses the action plan weights. The tuned weights are used at a subsequent iteration of the reinforcement learning. The iterations continue until feedback at one of the iterations indicates that an expected ranking is close to or the same and a generated ranking, and the weights updated at that iteration are deployed in the action plan scorer 513 to score action plans for priority resolution at the organization. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
iteratively updating weights of scoring variables to score a plurality of action plans, wherein iteratively updating the weights of the scoring variables comprises, at each iteration of one or more iterations,
scoring the plurality of action plans to prioritize resolution based, at least in part, on the weights to generate a plurality of scores;
generating a ranking of the plurality of action plans according to the plurality of scores;
obtaining feedback on the generated ranking;
based on the feedback indicating that the generated ranking is incorrect,
determining, from the feedback, an expected ranking of the plurality of action plans; and
updating the weights to lower a value of a loss function between the generated ranking and the expected ranking; and
based on the feedback indicating that the generated ranking is correct, storing the updated weights to subsequently score action plans.

2. The method of claim 1, wherein the loss function comprises a weighted sum of differences between expected ranks and generated ranks of each of the plurality of action plans.

3. The method of claim 1, wherein the feedback comprises indicators that one or more of the plurality of action plans should be ranked at least one of higher and lower in the generated ranking.

4. The method of claim 1, further comprising, at each iteration, grouping the plurality of action plans based, at least in part, on the generated ranking and values of the scoring variables of the action plans to obtain one or more groupings.

5. The method of claim 1, wherein the scoring variables comprise scoring variables of risk, resolution impact, and resolution complexity and weights of the scoring variables.

6. The method of claim 5, wherein those of the scoring variables of risk comprise maximum alert risk score, sum of alert risk scores, and maximum asset criticality, wherein those of the scoring variables of resolution impact comprise number of issues and number of assets, wherein one of the scoring variables of resolution complexity comprises number of policies.

7. The method of claim 1, further comprising:
scoring additional action plans with the updated weights;
ranking the additional action plans according to corresponding scores from the scoring to generate an additional ranking; and
resolving the additional action plans according to corresponding ranks from the additional ranking.

8. The method of claim 1, wherein updating the weights comprises updating the weights with an optimization algorithm.

9. A non-transitory machine-readable medium having program code stored thereon, the program code comprising instructions to:
iteratively update weights of scoring variables to score a plurality of action plans, wherein the instructions to iteratively update the weights of the scoring variables comprise instructions to, at each iteration of one or more iterations,
score the plurality of action plans to prioritize resolution based, at least in part, on the weights to generate a plurality of scores;
generate a ranking of the plurality of action plans according to the plurality of scores;
obtain feedback on the generated ranking;
determine, from the feedback, an expected ranking of the plurality of action plans;
based on at least one of the feedback and the expected ranking indicating that the generated ranking is incorrect, update the weights to lower a value of a loss function between the generated ranking and the expected ranking; and
based on at least one of the feedback and the expected ranking indicating that the generated ranking is correct, storing the updated weights to subsequently score action plans.

10. The non-transitory machine-readable medium of claim 9, wherein the loss function comprises a weighted sum of differences between expected ranks and generated ranks of each of the plurality of action plans.

11. The non-transitory machine-readable medium of claim 9, wherein the feedback comprises indicators that one or more of the plurality of action plans should be ranked at least one of higher and lower in the generated ranking.

12. The non-transitory machine-readable medium of claim 9, wherein the program code further comprises instructions to, at each iteration, group the plurality of action plans based, at least in part, on the generated ranking and values of the scoring variables of the action plans to obtain one or more groupings.

13. The non-transitory machine-readable medium of claim 9, wherein the scoring variables comprise scoring variables of risk, resolution impact, and resolution complexity and weights of the scoring variables.

14. The non-transitory machine-readable medium of claim 13, wherein those of the scoring variables of risk comprise maximum alert risk score, sum of alert risk scores, and maximum asset criticality, wherein those of the scoring variables of resolution impact comprise number of issues and number of assets, wherein one of the scoring variables of resolution complexity comprises number of policies.

15. The non-transitory machine-readable medium of claim 9, wherein the program code further comprises instructions to:
score additional action plans with the updated weights;
rank the additional action plans according to corresponding scores from the scoring to generate an additional ranking; and
resolve the additional action plans according to corresponding ranks from the additional ranking.

16. An apparatus comprising:
a processor; and
a machine-readable medium having instructions stored thereon that are executable by the processor to cause the apparatus to,
receive a plurality of action plans of an organization;
score the plurality of action plans to prioritize resolution based, at least in part, on one or more weights for scoring variables of action plans to generate a plurality of scores;
rank the plurality of action plans according to the plurality of scores to generate a ranking;
communicate the generated ranking to receive feedback from the organization in response;
determine a loss value for the generated ranking based on the feedback;
based on the loss value indicating that the generated ranking is incorrect, updating the one or more weights to reduce the loss value; and
based on the loss value indicating that the generated ranking is correct, deploy the one or more weights to score action plans of the organization.

17. The apparatus of claim 16, wherein the instructions to determine the loss value for the generated ranking comprise instructions executable by the processor to cause the apparatus to:
determine an expected ranking for the plurality of action plans based on the feedback; and
compute the loss value as a weighted sum of a difference between the expected ranking and the generated ranking.

18. The apparatus of claim 16, wherein the feedback comprises indicators that one or more of the plurality of action plans should be ranked at least one of higher and lower in the generated ranking.

19. The apparatus of claim 16, wherein the scoring variables comprise scoring variables of risk, resolution impact, and resolution complexity and weights of the scoring variables.

20. The apparatus of claim 19, wherein those of the scoring variables of risk comprise maximum alert risk score, sum of alert risk scores, and maximum asset criticality, wherein those of the scoring variables of resolution impact comprise number of issues and number of assets, wherein one of the scoring variables of resolution complexity comprises number of policies.
